(19) United States
(12) Patent Application Publication
(10) Pub. No.: US 2013/0050016 A1
(43) Pub. Date: Feb. 28, 2013

(54) RADAR PACKAGE FOR MILLIMETER WAVES

(71) Applicants: Cheon Soo KIM, Daejeon (KR); Hyun Kyu YU, Daejeon (KR)

(72) Inventors: Cheon Soo KIM, Daejeon (KR); Hyun Kyu YU, Daejeon (KR)

(73) Assignee: Electronics and Telecommunications Research Institute, Daejeon (KR)

(21) Appl. No.: 13/594,173

(22) Filed: Aug. 24, 2012

(30) Foreign Application Priority Data
Aug. 26, 2011 (KR) 10-2011-0086009
Aug. 22, 2012 (KR) 10-2012-0091923

(51) Int. Cl. G01S 13/00

(52) U.S. Cl. 342/195; 342/175

(57) ABSTRACT

The present invention relates to a radar package for millimeter waves. A small-size, low-cost, light-weight, and high-precision radar sensor can be embodied by packaging an antenna, transceiver chips, and a digital signal processing chip into a radar-on chip through TSVs in order to reduce the size and integrate the antenna, the transceiver chips, and the digital signal processing chip into one package. Accordingly, a radar sensor for ultra-high precision, applicable to a radar for vehicles, an imaging system for weapon monitoring, and a radar for small-sized, light-weight, and precision measurement, all of which have a millimeter band, and to the autonomous traveling of a robot, can be embodied.

### CROSS-REFERENCES TO RELATED APPLICATIONS

The present application claims priority under 35 U.S.C 119(a) to Korean Application No. 10-2011-0086009, filed on Aug. 26, 2011, in the Korean Intellectual Property Office and Korean Application No. 10-2012-0091923, filed on Aug. 22, 2012, in the Korean Intellectual Property Office, which are incorporated herein by reference in its entirety set forth in full.

### BACKGROUND

Exemplary embodiments of the present invention relate to radar packages for millimeter waves, and more particularly, to radar packages for millimeter waves in each of which an antenna, transceiver chips, and a digital signal processing chip are packaged into a radar-on chip through Through Silicon Vias (TSVs) in order to reduce the size and integrate the antenna, the transceiver chip, and the digital signal processing chip into one package.

As Complementary Metal-Oxide Semiconductor (CMOS) is recently able to operate up to a millimeter band, CMOS chips that operate in a millimeter band of a 60 GHz band start appearing. Furthermore, it is expected that an antenna will be eventually integrated into a chip because a wavelength becomes short according to a further rise of the operating frequency and thus the size of the antenna is gradually reduced.

FIG. 1 is a diagram showing a known radar package for millimeter waves.

As shown in FIG. 1, the radar package for millimeter waves using a common method has a structure in which a transceiver chip 20 and a patch antenna 10 are integrated into substrates having the same or different dielectric constants.

In the case of millimeter waves, there is a good possibility that a lot of a loss may occur in the connection of the patch antenna 10 and the transceiver chip 20. In order to reduce the loss between the patch antenna 10 and the transceiver chip 20, the patch antenna 10 is also integrated into the transceiver chip 20 or another chip.

The size of the patch antenna 10 in which an array antenna is formed in a patch form in a frequency of 100 GHz or lower, however, is several times greater than that of the transceiver chip 20. Accordingly, there is a problem in reducing the cost of the patch antenna 10 although the patch antenna 10, together with the transceiver chip 20, is integrated into the same chip.

Furthermore, if the patch antenna 10 having a large area, together with the transceiver chip 20, is integrated into the same chip, manufacturing cost rises because process technology of a nanometer level is necessary in order for a CMOS device to operate in millimeter waves at a high speed.

In contrast, the design rule of the patch antenna 10 is much less strict than that of CMOS technology, and thus a cheap antenna may be designed if CMOS technology of a micrometer level is used.

Meanwhile, the degree of integration of CMOS Dynamic Random Access Memory (DRAM) devices increases according to a rule that the memory capacity of the CMOS DRAM device is doubled every two years. An increase in the degree of 2-D integration has almost reached the limit, and thus the degree of integration of memory devices is recently increased in a 3-D manner using TSV technology by stacking fabricated DRAM devices.

As a related prior art, there is U.S. Pat. No. 6,507,311 (Jan. 14, 2003), entitled ‘Device and Process for Measuring Distance and Speed’.

### SUMMARY

An embodiment of the present invention relates to a radar package for millimeter waves in which an antenna, transceiver chips, and a digital signal processing chip are packaged into a radar-on chip through TSVs in order to reduce the size and integrate the antenna, the transceiver chips, and the digital signal processing chip into one package.

In one embodiment, a radar package for millimeter waves having a radar-on chip structure includes transceiver chips configured to have transceiver modules mounted thereon and a patch antenna configured to have patch type array antennas disposed in a silicon substrate and electrically connected to the transceiver chips through TSVs.

In the present invention, the patch antenna is formed on the silicon substrate using any one of a polymer substrate, a sapphire substrate, and a glass substrate after removing a backside of the silicon substrate.

In the present invention, the backside is removed by lapping.

In the present invention, the silicon substrate is a high-resistance silicon substrate.

In the present invention, the radar package further includes a feeding network disposed between the transceiver chips and the patch antenna and configured to transfer an electric field signal through a waveguide.

In the present invention, the radar package further includes solder balls for flip-chip bonding under the transceiver chips for the input and output of the transceiver modules.

In another embodiment, a radar package for millimeter waves having a radar-on chip structure includes a digital signal processing chip configured to have a digital signal processing module for processing a radar signal mounted thereon, transceiver chips configured to have transceiver modules mounted thereon and electrically connected to the digital signal processing chip through TSVs, and a patch antenna configured to have patch type array antennas disposed in a silicon substrate and electrically connected to the transceiver chips through the TSVs.

In the present invention, the patch antenna is formed on the silicon substrate using any one of a polymer substrate, a sapphire substrate, and a glass substrate after removing a backside of the silicon substrate.

In the present invention, the backside is removed by lapping.

In the present invention, the silicon substrate is a high-resistance silicon substrate.

In the present invention, the radar package further includes a feeding network disposed between the transceiver chips and the patch antenna and configured to transfer an electric field signal.

In the present invention, the radar package further includes solder balls for flip-chip bonding under the digital signal processing chip for the input and output of the transceiver modules.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram showing a known radar package for millimeter waves;

FIGS. 2 and 3 are 3-D diagrams showing a radar package for millimeter waves in accordance with one embodiment of the present invention; and

FIGS. 4 and 5 are a 3-D diagram and a cross-sectional view showing a radar package for millimeter waves in accordance with another embodiment of the present invention.

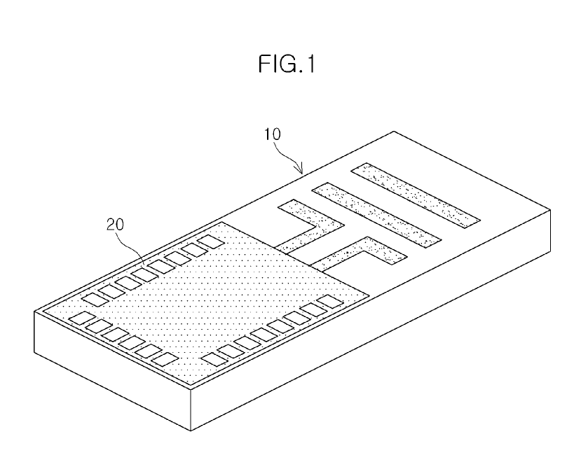

### DESCRIPTION OF SPECIFIC EMBODIMENTS

Hereinafter, radar packages for millimeter waves according to embodiments of the present invention will be described with reference to accompanying drawings. However, the embodiments are for illustrative purposes only and are not intended to limit the scope of the invention.

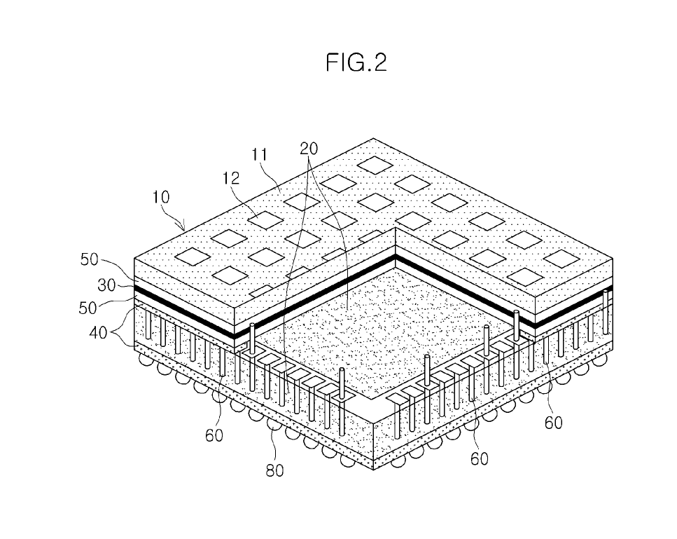

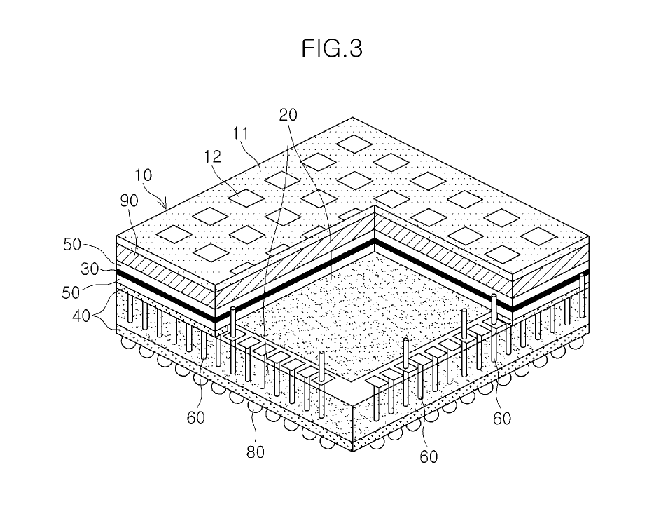

FIGS. 2 and 3 are 3-D diagrams showing a radar package for millimeter waves in accordance with one embodiment of the present invention.

As shown in FIG. 2, the radar package for millimeter waves in accordance with one embodiment of the present invention is a package of a radar-on chip in which transceiver chips 20 and a patch antenna 10 are stacked and electrically coupled through TSVs 60.

That is, transmission modules, such as a high power amplifier, a phase shifter, a digital attenuator, a single pole double throw switch, and a drive amplifier, and reception modules, such as a single pole double throw switch, a limiter, and a gain block amplifier, can be mounted on the transceiver chips 20.

The patch antenna 10 includes patch type array antennas 12 disposed in a silicon substrate 11.

Furthermore, a feeding network 50 for transferring an electric field signal through a waveguide and a ground plane 30 for the resistance, shielding, and heat radiation of transmission waves that pass through a conductive circuit are formed between the transceiver chips 20 and the patch antenna 10.

Furthermore, solder balls 80 for flip-chip bonding are formed under the transceiver chips 20 for the input and output of a transceiver module.

As described above, the patch type array antennas 12 of the patch antenna 10 are arranged over the transceiver chips 20, electrically connected through the TSVs 60, and packaged into a stack structure.

Adhesives 40 can be used in order to fix the transceiver chips 20 and the patch antenna 10 physically.

The TSVs 60 are formed by forming vias in the transceiver chips 20 and the patch antenna 10 and filling the vias with a conductive film. The TSVs 60 electrically couple stacked chips.

The electrical connection through the TSVs 60 does not need an additional area for the electrical connection and a gap for wire bonding between the chips and can reduce the total size and height and improve the operating speed of the chips because a signal connection length is short.

Meanwhile, if the patch antenna 10 is formed by disposing the patch type array antennas 12 on the silicon substrate 11, a great magnetic loss due to the silicon substrate 11 is generated because the silicon substrate 11 has a high dielectric constant ∈ᵣ of 12.3. In order to reduce the magnetic loss, the silicon substrate 11 may be formed of a high-resistance silicon substrate.

In some embodiments, as shown in FIG. 3, a low loss substrate 90 of a low magnetic loss, such as a polymer substrate, a sapphire substrate, or a glass substrate, may be formed on the silicon substrate 11 after removing the backside of the silicon substrate 11 according to a mechanical method using lapping.

If a digital signal processing chip for digital signal processing is integrated into the transceiver chips 20 as a single chip, the digital signal processing chip may be packaged into a structure, such as that shown in FIG. 2 or 3.

As described above, the size of the patch antenna 10, the transceiver chips 20, and the digital signal processing chip is reduced by packaged them into a radar-on chip through the TSV package technology. A radar sensor for ultra-high precision, applicable to a radar for vehicles, an imaging system for weapon monitoring, and a radar for small-sized, light-weight, and precision measurement, all of which have a millimeter band, and to the autonomous traveling of a robot, can be embodied.

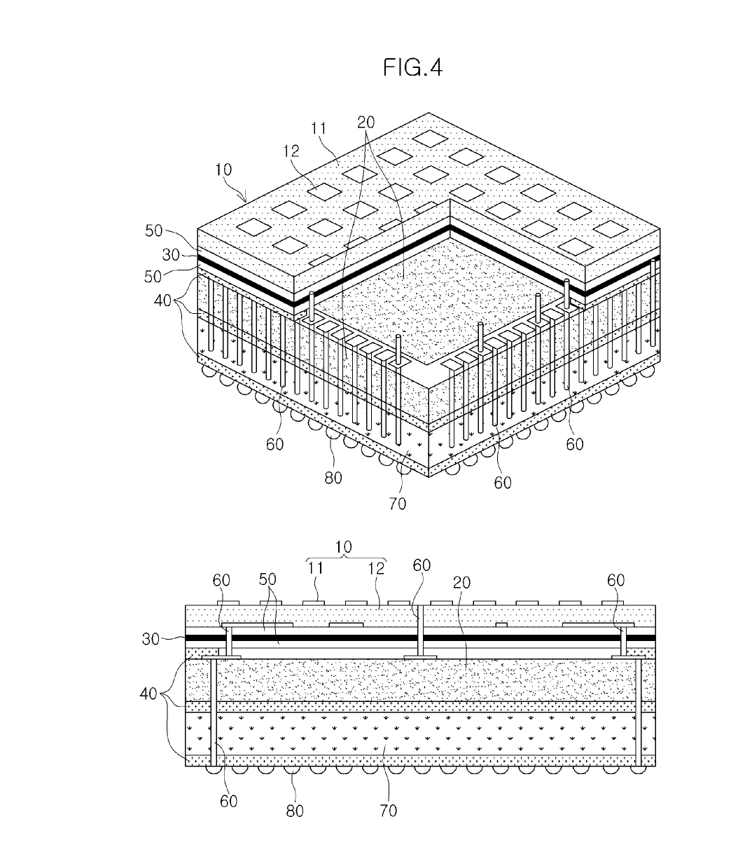

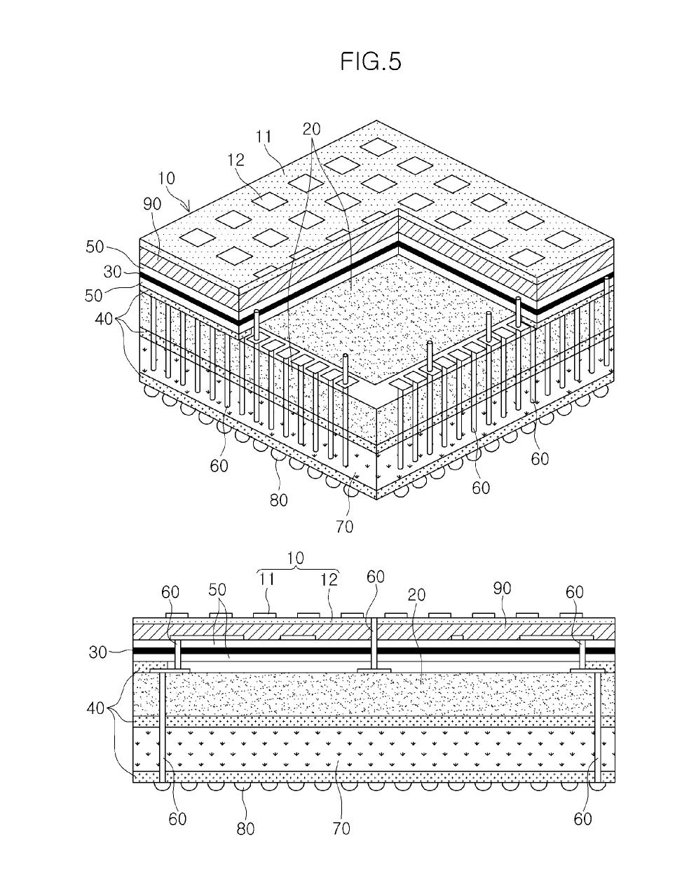

FIGS. 4 and 5 are a 3-D diagram and a cross-sectional view showing a radar package for millimeter waves in accordance with another embodiment of the present invention.

As shown in FIG. 4, the radar package for millimeter waves in accordance with another embodiment of the present invention is a package of a radar-on chip in which a digital signal processing chip 70, transceiver chips 20, and a patch antenna 10 are stacked and chips are electrically connected through TSVs 60.

A digital signal processing module for processing a radar signal is mounted on the digital signal processing chip 70.

Transmission modules, such as a high power amplifier, a phase shifter, a digital attenuator, a single pole double throw switch, and a drive amplifier, and reception modules, such as a single pole double throw switch, a limiter, and a gain block amplifier, can be mounted on the transceiver chips 20.

The patch antenna 10 includes patch type array antennas 12 disposed in a silicon substrate 11.

Furthermore, a feeding network 50 for transferring an electric field signal through a waveguide and a ground plane 30 for the resistance, shielding, and heat radiation of transmission waves that pass through a conductive circuit are formed between the transceiver chips 20 and the patch antenna 10.

Furthermore, solder balls 80 for flip-chip bonding are formed under the digital signal processing chip 70 for the input and output of a transceiver module.

As described above, the digital signal processing chip 70, the transceiver chips 20, and the patch antenna 10 are vertically stacked, electrically connected through the TSVs 60, and packaged into a stack structure.

Adhesives 40 can be used in order to fix the digital signal processing chip 70, the transceiver chips 20, and the patch antenna 10 physically.

The TSVs 60 are formed by forming vias in the transceiver chips 20 and the patch antenna 10 and filling the vias with a conductive film. The TSVs 60 electrically couple stacked chips.

The electrical connection through the TSVs 60 does not need an additional area for the electrical connection and a gap for wire bonding between the chips and can reduce the total size and height and improve the operating speed of the chips because a signal connection length is short.

Meanwhile, if the patch antenna 10 is formed by disposing the patch type array antennas 12 on the silicon substrate 11, a great magnetic loss due to the silicon substrate 11 is generated because the silicon substrate 11 has a high dielectric constant ∈ᵣ of 12.3. In order to reduce the magnetic loss, the silicon substrate 11 may be formed of a high-resistance silicon substrate.

In some embodiments, as shown in FIG. 5, a low loss substrate 90 of a low magnetic loss, such as a polymer substrate, a sapphire substrate, or a glass substrate, may be formed on the silicon substrate 11 after removing the backside of the silicon substrate 11 according to a mechanical method using lapping.

As described above, the radar package for millimeter waves, having the radar-on chip structure, in accordance with the present invention has the following excellent advantages.

First, since the radar package of the radar-on chip structure is constructed using the TSVs, a feeding length of millimeter waves between the antenna and the transceiver chips can be shortened. Accordingly, the attenuation of a signal occurring when the antenna and the chips are coupled, that is, the most significant problem in a radar system of a millimeter band, can be minimized.

Second, the position of the ground plane that functions as grounding even after flip-chip packaging is not changed in the radar package for millimeter waves having the radar-on chip structure. Thus, original circuit design characteristics are not changed and a stable operation can be guaranteed.

Third, the radar package of the radar-on chip structure is constructed using the TSVs as described above. Thus, a system can be fabricated at a low cost because the transceiver chips are fabricated using nano technology according to an expensive design rule of 65 nm or lower and the antenna is fabricated using manufacturing technology of a micrometer level according to a less strict design rule and then stacked.

Fourth, a system that is much lighter, thinner, shorter, and smaller than a system integrated using a Low Temperature Co-fired Ceramic (LTCC) substrate can be fabricated by constructing the radar package of the radar-on chip structure using the TSVs.

In accordance with the present invention, a small-size, low-cost, light-weight, and high-precision radar sensor can be embodied by packaging the antenna, the transceiver chips, and the digital signal processing chip into a radar-on chip through the TSVs in order to reduce the size and integrate the antenna, the transceiver chips, and the digital signal processing chip into one package. Accordingly, a radar sensor for ultra-high precision, applicable to a radar for vehicles, an imaging system for weapon monitoring, and a radar for small-sized, light-weight, and precision measurement, all of which have a millimeter band, and to the autonomous traveling of a robot, can be embodied.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A radar package for millimeter waves having a radar-on chip structure, the radar package comprising:
transceiver chips configured to have transceiver modules mounted thereon; and
a patch antenna configured to have patch type array antennas disposed in a silicon substrate and electrically connected to the transceiver chips through Through Silicon Via (TSVs).

2. The radar package of claim 1, wherein the patch antenna is formed on the silicon substrate using any one of a polymer substrate, a sapphire substrate, and a glass substrate after removing a backside of the silicon substrate.

3. The radar package of claim 2, wherein the backside is removed by lapping.

4. The radar package of claim 1, wherein the silicon substrate is a high-resistance silicon substrate.

5. The radar package of claim 1, further comprising a feeding network disposed between the transceiver chips and the patch antenna and configured to transfer an electric field signal through a waveguide.

6. The radar package of claim 1, further comprising solder balls for flip-chip bonding under the transceiver chips for an input and output of the transceiver modules.

7. A radar package for millimeter waves having a radar-on chip structure, the radar package comprising:
a digital signal processing chip configured to have a digital signal processing module for processing a radar signal mounted thereon;
transceiver chips configured to have transceiver modules mounted thereon and electrically connected to the digital signal processing chip through Through Silicon Vias (TSVs); and
a patch antenna configured to have patch type array antennas disposed in a silicon substrate and electrically connected to the transceiver chips through the TSVs.

8. The radar package of claim 7, wherein the patch antenna is formed on the silicon substrate using any one of a polymer substrate, a sapphire substrate, and a glass substrate after removing a backside of the silicon substrate.

9. The radar package of claim 8, wherein the backside is removed by lapping.

10. The radar package of claim 7, wherein the silicon substrate is a high-resistance silicon substrate.

11. The radar package of claim 7, further comprising a feeding network disposed between the transceiver chips and the patch antenna and configured to transfer an electric field signal.

12. The radar package of claim 7, further comprising solder balls for flip-chip bonding under the digital signal processing chip for an input and output of the transceiver modules.
